(19) United States
(12) Patent Application Publication
(10) Pub. No.: US 2025/0273995 A1
(43) Pub. Date: Aug. 28, 2025

(54) TECHNIQUES FOR PRE-CHARGING WEARABLE DEVICES WHILE PACKAGED

(71) Applicant: Oura Health Oy, Oulu (FI)

(72) Inventors: Simon Ratner, San Francisco, CA (US); Alfredo Granda, Lima (PE)

(21) Appl. No.: 19/055,317

(22) Filed: Feb. 17, 2025

Related U.S. Application Data
(60) Provisional application No. 63/556,702, filed on Feb. 22, 2024.

(51) Int. Cl. H02J 50/12; H02J 7/00; H02J 50/40; H02J 50/90

(52) U.S. Cl. CPC H02J 50/12; H02J 7/0048; H02J 7/00712; H02J 50/402; H02J 50/90

(57) ABSTRACT

Methods, systems, and devices for a wearable device charger are described. The wearable device charger may include a first charging component capable of wirelessly receiving energy and a second charging component capable of wirelessly transmitting energy. As such, a wearable device may be placed on or within the wearable device charger and both may be positioned within a shipping apparatus. The shipping apparatus may be positioned within a threshold proximity of a wireless charging apparatus, such that the wireless charging apparatus may wirelessly transfer energy to the wearable device charger via the first charging component. Further, the wearable device charger may charge the wearable device within the shipping apparatus via the second charging component based on wirelessly receiving energy from the wireless charging apparatus. As such, the wearable device may transition from an inactive mode to an active mode based on the charging.

### CROSS REFERENCE

The present Application for Patent claims the benefit of U.S. Provisional Patent Application No. 63/556,702 by Ratner et al., entitled “TECHNIQUES FOR PRE-CHARGING WEARABLE DEVICES WHILE PACKAGED,” filed Feb. 22, 2024, assigned to the assignee hereof, and expressly incorporated by reference herein.

### FIELD OF TECHNOLOGY

The following relates to wearable devices and data processing, including techniques for pre-charging wearable devices while packaged.

### BACKGROUND

Some wearable devices may be configured to collect data from users to help the users understand more about their overall physiological health and well-being. However, after purchasing a wearable device, a user typically has to remove the wearable device from packaging, place the wearable device on a charger, plug in the charger, perform firmware updates, and set user settings prior to being able to use the wearable device, which may result in increased latency that decreases the user's experience.

### BRIEF DESCRIPTION OF THE DRAWINGS

FIG. 1 illustrates an example of a system that supports techniques for pre-charging wearable devices while packaged in accordance with aspects of the present disclosure.

FIG. 2 illustrates an example of a system that supports techniques for pre-charging wearable devices while packaged in accordance with aspects of the present disclosure.

FIG. 3 shows an example of a system that supports techniques for pre-charging wearable devices while packaged in accordance with aspects of the present disclosure.

FIG. 4 shows an example of a system that supports techniques for pre-charging wearable devices while packaged in accordance with aspects of the present disclosure.

FIG. 5 shows an example of a system that supports techniques for pre-charging wearable devices while packaged in accordance with aspects of the present disclosure.

FIG. 6 shows a flowchart illustrating methods that support techniques for pre-charging wearable devices while packaged in accordance with aspects of the present disclosure.

### DETAILED DESCRIPTION

Many wearable devices are typically battery-powered, such as via a lithium battery. In some cases, a battery used to power a wearable device may be damaged or destroyed if the battery is left fully drained for an extended period of time (e.g., remains without a charge for a threshold duration). As such, to protect the battery during shipment, wearable devices may be pre-charged to some level (e.g., 20-80%) and turned off during shipment (e.g., turned to a “ship mode” after manufacturing and testing). However, many wearable devices, such as wearable ring devices, do not have physical on and off buttons. Thus, in order to turn the wearable device on (e.g., transition the wearable device out of “ship mode”), a user may need to remove the wearable device and charger from the shipment packaging, plug the charger in, place the wearable device on the charger to transition the device out of “ship mode,” and potentially wait for one or more updates to occur and/or for one or more user settings to be applied prior using the wearable device. This process may result in increased latency that decreases user experience. This latency issue may further be compounded in bulk distribution cases where wearable devices are shipped in bulk (e.g., research studies, military applications, enterprise customers, etc.) and where an administrative user may be required to unpackage, charge/activate, update/configure, then repackage multiple (e.g., hundreds) of wearable devices prior to distributing the wearable devices to end users.

Thus, to improve user experience and reduce latency, specifically in bulk distribution scenarios, techniques described herein support techniques for pre-charging and activating wearable devices while the wearable devices are packaged for shipment (e.g., when the wearable devices are in shipment packaging). For example, a wearable device, such as a wearable ring device, may be placed on or within a device charger that can wirelessly receive energy from a charging pad (e.g., wireless charging device) through the shipment packaging to temporarily turn on the wearable ring device for updates, pre-configuration, or both, while the wearable ring device is still packaged. Specifically, a wearable ring device may be put into a “ship mode” (e.g., turned off), positioned on or within the device charger, and packaged for shipment while positioned on the device charger. In such cases, the wearable ring device may be packaged in such a manner that movement of the wearable ring device on or within the device charger is limited to prevent damage during shipment due to contact between the wearable ring device and the device charger.

Additionally, the device charger may include a first charging component configured to wirelessly receive power (e.g., from a “charging pad”) and a second charging component configured to wirelessly transmit power (e.g., to the wearable device). For example, the device charger may include a first contactless charging component (e.g., first inductive coil, first resonant charging component) capable of wirelessly receiving power, which may be referred to as an Rx contactless charging component, and a second contactless charging component (e.g., second inductive coil, second resonant charging component) capable of wirelessly transmitting power, which may be referred to as a Tx contactless charging component. In such cases, the Rx contactless charging component may be positioned at least partially within a first portion of the device charger, such as a base of the device charger, such that the first portion of the device charger can be placed within a first threshold proximity of the charging pad. Similarly, the Tx contactless charging component may be positioned at least partially within a second portion of the device charger where the wearable ring device is placed, such as in a charging post over which the wearable ring device is placed or within a charging cavity where the wearable ring device is inserted. In such cases, the Tx and Rx contactless charging components may be positioned a second threshold proximity away from each other, as to avoid interference between the wireless power reception and the wireless power transmission.

As such, when the shipment packaging containing the device charger and wearable ring device is placed within the first threshold proximity of the charging pad (e.g., on or near the charging pad), the Rx contactless charging component of the device charger may wirelessly receive power (e.g., energy) from the charging pad through the shipment packaging and may use the power to charge the wearable ring device via the Tx contactless charging component. In some cases, the device charger may directly transfer power from the Rx contactless charging component to the Tx contactless charging component. In some other cases, the device charger may include a battery or other power storage device, such that power received via the Rx contactless charging component is stored in the battery temporarily before being transmitted to the wearable ring device via the Tx contactless charging component.

Thus, the wearable ring device may be turned on (e.g., activated), thereby transitioning the wearable ring device out of the “ship mode,” while still in the shipment packaging. As such, a user, via a user device, may update firmware of the wearable ring device, pre-configure one or more settings (e.g., parameters, user preferences/characteristics) of the wearable ring device, or both. For example, in a research study scenario, multiple wearable ring devices may be activated while still in shipment packaging and each wearable ring device may be pre-configured with one or more settings specific to an intended user, with one or more settings specific to the research study, or both. That is, for illustrative purposes, each wearable ring device may be associated with a user profile containing an identification number, a user's height, a user's weight, and a user's age, such that the specific user may receive the wearable ring device pre-configured specifically for said user while the wearable ring device is still in the shipment packaging, including associated accessories.

In some cases, the wearable ring device may be unpackaged by the user within the threshold duration after updating, pre-configuring, or both, the wearable ring device, such that the wearable ring device may be left on (e.g., activated, in an active state) after updating, pre-configuring, or both, and can be worn and used by the user immediately after unpackaging the wearable ring device. For example, a first user may purchase the wearable ring device for a second user who is the intended user of the wearable ring device. As such, to prepare the wearable ring device to be gifted to the second user, the first user may update, pre-configure, or both, the wearable ring device a day before gifting the wearable ring device to the second user. Thus, after being gifted the wearable ring device, the second user may remove the wearable ring device from the packaging and immediately begin using the wearable ring device.

In some other cases, the wearable ring device may be unpackaged by the user outside of (e.g., exceeding) the threshold duration, such that leaving the wearable ring device on may risk damaging the battery. In such cases, after completion of updates, pre-configuration, or both, a user device (e.g., an application associated with the wearable ring device on a user device) may be used to return the wearable ring device to the “ship mode” to protect the battery life until the wearable ring device is removed from the shipment packaging for use by the user (e.g., or activated for a second time while still in the packaging). For example, continuing with the research study scenario, the administrative user may update and pre-configure the multiple wearable devices over a period of a week and may not distribute the multiple wearable devices for another week. As such, after updating and pre-configuring the multiple wearable devices, the administrative user may return the wearable ring devices to the “ship mode” and, after distribution, a user may activate their wearable ring device after removing the wearable ring devices from the shipment packaging and briefly placing the wearable ring device on the charger (e.g., without needing to update or pre-configure the wearable ring device).

Aspects of the disclosure are initially described in the context of systems supporting physiological data collection from users via wearable devices. Aspects of the disclosure are further illustrated by and described with reference to apparatus diagrams, system diagrams, and flowcharts that relate to techniques for pre-charging wearable devices while packaged.

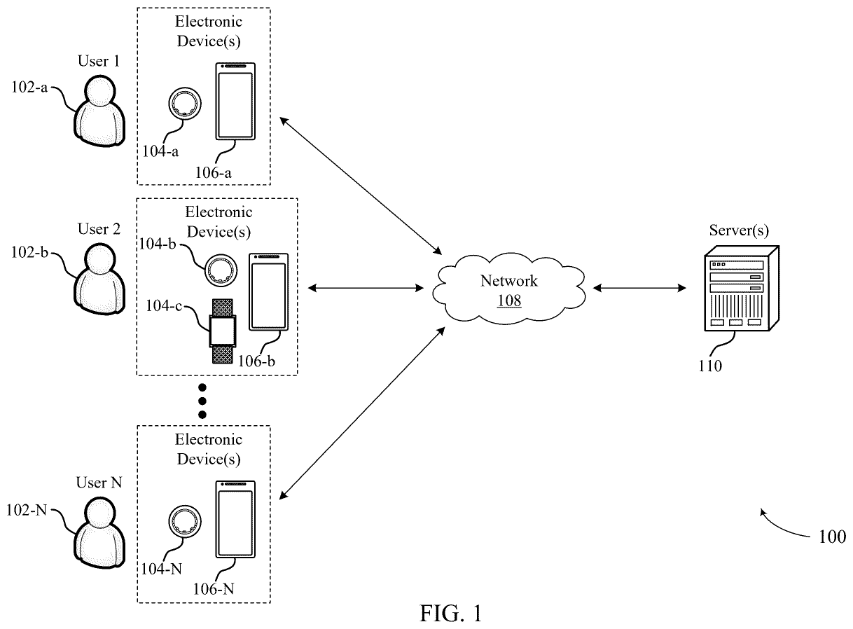

FIG. 1 illustrates an example of a system 100 that supports techniques for pre-charging wearable devices while packaged in accordance with aspects of the present disclosure. The system 100 includes a plurality of electronic devices (e.g., wearable devices 104, user devices 106) that may be worn and/or operated by one or more users 102. The system 100 further includes a network 108 and one or more servers 110.

The electronic devices may include any electronic devices known in the art, including wearable devices 104 (e.g., ring wearable devices, watch wearable devices, etc.), user devices 106 (e.g., smartphones, laptops, tablets). The electronic devices associated with the respective users 102 may include one or more of the following functionalities: 1) measuring physiological data, 2) storing the measured data, 3) processing the data, 4) providing outputs (e.g., via GUIs) to a user 102 based on the processed data, and 5) communicating data with one another and/or other computing devices. Different electronic devices may perform one or more of the functionalities.

Example wearable devices 104 may include wearable computing devices, such as a ring computing device (hereinafter “ring”) configured to be worn on a user's 102 finger, a wrist computing device (e.g., a smart watch, fitness band, or bracelet) configured to be worn on a user's 102 wrist, and/or a head mounted computing device (e.g., glasses/goggles). Wearable devices 104 may also include bands, straps (e.g., flexible or inflexible bands or straps), stick-on sensors, and the like, that may be positioned in other locations, such as bands around the head (e.g., a forehead headband), arm (e.g., a forearm band and/or bicep band), and/or leg (e.g., a thigh or calf band), behind the ear, under the armpit, and the like. Wearable devices 104 may also be attached to, or included in, articles of clothing. For example, wearable devices 104 may be included in pockets and/or pouches on clothing. As another example, wearable device 104 may be clipped and/or pinned to clothing, or may otherwise be maintained within the vicinity of the user 102. Example articles of clothing may include, but are not limited to, hats, shirts, gloves, pants, socks, outerwear (e.g., jackets), and undergarments. In some implementations, wearable devices 104 may be included with other types of devices such as training/sporting devices that are used during physical activity. For example, wearable devices 104 may be attached to, or included in, a bicycle, skis, a tennis racket, a golf club, and/or training weights.

Much of the present disclosure may be described in the context of a ring wearable device 104. Accordingly, the terms “ring 104,” “wearable device 104,” and like terms, may be used interchangeably, unless noted otherwise herein. However, the use of the term “ring 104” is not to be regarded as limiting, as it is contemplated herein that aspects of the present disclosure may be performed using other wearable devices (e.g., watch wearable devices, necklace wearable device, bracelet wearable devices, earring wearable devices, anklet wearable devices, and the like).

In some aspects, user devices 106 may include handheld mobile computing devices, such as smartphones and tablet computing devices. User devices 106 may also include personal computers, such as laptop and desktop computing devices. Other example user devices 106 may include server computing devices that may communicate with other electronic devices (e.g., via the Internet). In some implementations, computing devices may include medical devices, such as external wearable computing devices (e.g., Holter monitors). Medical devices may also include implantable medical devices, such as pacemakers and cardioverter defibrillators. Other example user devices 106 may include home computing devices, such as internet of things (IoT) devices (e.g., IoT devices), smart televisions, smart speakers, smart displays (e.g., video call displays), hubs (e.g., wireless communication hubs), security systems, smart appliances (e.g., thermostats and refrigerators), and fitness equipment.

Some electronic devices (e.g., wearable devices 104, user devices 106) may measure physiological parameters of respective users 102, such as photoplethysmography waveforms, continuous skin temperature, a pulse waveform, respiration rate, heart rate, heart rate variability (HRV), actigraphy, galvanic skin response, pulse oximetry, blood oxygen saturation (SpO2), blood sugar levels (e.g., glucose metrics), and/or other physiological parameters. Some electronic devices that measure physiological parameters may also perform some/all of the calculations described herein. Some electronic devices may not measure physiological parameters, but may perform some/all of the calculations described herein. For example, a ring (e.g., wearable device 104), mobile device application, or a server computing device may process received physiological data that was measured by other devices.

In some implementations, a user 102 may operate, or may be associated with, multiple electronic devices, some of which may measure physiological parameters and some of which may process the measured physiological parameters. In some implementations, a user 102 may have a ring (e.g., wearable device 104) that measures physiological parameters. The user 102 may also have, or be associated with, a user device 106 (e.g., mobile device, smartphone), where the wearable device 104 and the user device 106 are communicatively coupled to one another. In some cases, the user device 106 may receive data from the wearable device 104 and perform some/all of the calculations described herein. In some implementations, the user device 106 may also measure physiological parameters described herein, such as motion/activity parameters.

For example, as illustrated in FIG. 1, a first user 102-a (User 1) may operate, or may be associated with, a wearable device 104-a (e.g., ring 104-a) and a user device 106-a that may operate as described herein. In this example, the user device 106-a associated with user 102-a may process/store physiological parameters measured by the ring 104-a. Comparatively, a second user 102-b (User 2) may be associated with a ring 104-b, a watch wearable device 104-c (e.g., watch 104-c), and a user device 106-b, where the user device 106-b associated with user 102-b may process/store physiological parameters measured by the ring 104-b and/or the watch 104-c. Moreover, an nth user 102-n (User N) may be associated with an arrangement of electronic devices described herein (e.g., ring 104-n, user device 106-n). In some aspects, wearable devices 104 (e.g., rings 104, watches 104) and other electronic devices may be communicatively coupled to the user devices 106 of the respective users 102 via Bluetooth, Wi-Fi, and other wireless protocols. Moreover, in some cases, the wearable device 104 and the user device 106 may be included within (or make up) the same device. For example, in some cases, the wearable device 104 may be configured to execute an application associated with the wearable device 104, and may be configured to display data via a GUI.

In some implementations, the rings 104 (e.g., wearable devices 104) of the system 100 may be configured to collect physiological data from the respective users 102 based on arterial blood flow within the user's finger. In particular, a ring 104 may utilize one or more light-emitting components, such as LEDs (e.g., red LEDs, green LEDs) that emit light on the palm-side of a user's finger to collect physiological data based on arterial blood flow within the user's finger. In general, the terms light-emitting components, light-emitting elements, and like terms, may include, but are not limited to, LEDs, micro LEDs, mini LEDs, laser diodes (LDs) (e.g., vertical cavity surface-emitting lasers (VCSELs), and the like.

In some cases, the system 100 may be configured to collect physiological data from the respective users 102 based on blood flow diffused into a microvascular bed of skin with capillaries and arterioles. For example, the system 100 may collect PPG data based on a measured amount of blood diffused into the microvascular system of capillaries and arterioles. In some implementations, the ring 104 may acquire the physiological data using a combination of both green and red LEDs. The physiological data may include any physiological data known in the art including, but not limited to, temperature data, accelerometer data (e.g., movement/motion data), heart rate data, HRV data, blood oxygen level data, or any combination thereof.

The use of both green and red LEDs may provide several advantages over other solutions, as red and green LEDs have been found to have their own distinct advantages when acquiring physiological data under different conditions (e.g., light/dark, active/inactive) and via different parts of the body, and the like. For example, green LEDs have been found to exhibit better performance during exercise. Moreover, using multiple LEDs (e.g., green and red LEDs) distributed around the ring 104 has been found to exhibit superior performance as compared to wearable devices that utilize LEDs that are positioned close to one another, such as within a watch wearable device. Furthermore, the blood vessels in the finger (e.g., arteries, capillaries) are more accessible via LEDs as compared to blood vessels in the wrist. In particular, arteries in the wrist are positioned on the bottom of the wrist (e.g., palm-side of the wrist), meaning only capillaries are accessible on the top of the wrist (e.g., back of hand side of the wrist), where wearable watch devices and similar devices are typically worn. As such, utilizing LEDs and other sensors within a ring 104 has been found to exhibit superior performance as compared to wearable devices worn on the wrist, as the ring 104 may have greater access to arteries (as compared to capillaries), thereby resulting in stronger signals and more valuable physiological data.

The electronic devices of the system 100 (e.g., user devices 106, wearable devices 104) may be communicatively coupled to one or more servers 110 via wired or wireless communication protocols. For example, as shown in FIG. 1, the electronic devices (e.g., user devices 106) may be communicatively coupled to one or more servers 110 via a network 108. The network 108 may implement transfer control protocol and internet protocol (TCP/IP), such as the Internet, or may implement other network 108 protocols. Network connections between the network 108 and the respective electronic devices may facilitate transport of data via email, web, text messages, mail, or any other appropriate form of interaction within a computer network 108. For example, in some implementations, the ring 104-a associated with the first user 102-a may be communicatively coupled to the user device 106-a, where the user device 106-a is communicatively coupled to the servers 110 via the network 108. In additional or alternative cases, wearable devices 104 (e.g., rings 104, watches 104) may be directly communicatively coupled to the network 108.

The system 100 may offer an on-demand database service between the user devices 106 and the one or more servers 110. In some cases, the servers 110 may receive data from the user devices 106 via the network 108, and may store and analyze the data. Similarly, the servers 110 may provide data to the user devices 106 via the network 108. In some cases, the servers 110 may be located at one or more data centers. The servers 110 may be used for data storage, management, and processing. In some implementations, the servers 110 may provide a web-based interface to the user device 106 via web browsers.

In some aspects, the system 100 may detect periods of time that a user 102 is asleep, and classify periods of time that the user 102 is asleep into one or more sleep stages (e.g., sleep stage classification). For example, as shown in FIG. 1, User 102-a may be associated with a wearable device 104-a (e.g., ring 104-a) and a user device 106-a. In this example, the ring 104-a may collect physiological data associated with the user 102-a, including temperature, heart rate, HRV, respiratory rate, and the like. In some aspects, data collected by the ring 104-a may be input to a machine learning classifier, where the machine learning classifier is configured to determine periods of time that the user 102-a is (or was) asleep. Moreover, the machine learning classifier may be configured to classify periods of time into different sleep stages, including an awake sleep stage, a rapid eye movement (REM) sleep stage, a light sleep stage (non-REM (NREM)), and a deep sleep stage (NREM). In some aspects, the classified sleep stages may be displayed to the user 102-a via a GUI of the user device 106-a. Sleep stage classification may be used to provide feedback to a user 102-a regarding the user's sleeping patterns, such as recommended bedtimes, recommended wake-up times, and the like. Moreover, in some implementations, sleep stage classification techniques described herein may be used to calculate scores for the respective user, such as Sleep Scores, Readiness Scores, and the like.

In some aspects, the system 100 may utilize circadian rhythm-derived features to further improve physiological data collection, data processing procedures, and other techniques described herein. The term circadian rhythm may refer to a natural, internal process that regulates an individual's sleep-wake cycle, that repeats approximately every 24 hours. In this regard, techniques described herein may utilize circadian rhythm adjustment models to improve physiological data collection, analysis, and data processing. For example, a circadian rhythm adjustment model may be input into a machine learning classifier along with physiological data collected from the user 102-a via the wearable device 104-a. In this example, the circadian rhythm adjustment model may be configured to “weight,” or adjust, physiological data collected throughout a user's natural, approximately 24-hour circadian rhythm. In some implementations, the system may initially start with a “baseline” circadian rhythm adjustment model, and may modify the baseline model using physiological data collected from each user 102 to generate tailored, individualized circadian rhythm adjustment models that are specific to each respective user 102.

In some aspects, the system 100 may utilize other biological rhythms to further improve physiological data collection, analysis, and processing by phase of these other rhythms. For example, if a weekly rhythm is detected within an individual's baseline data, then the model may be configured to adjust “weights” of data by day of the week. Biological rhythms that may require adjustment to the model by this method include: 1) ultradian (faster than a day rhythms, including sleep cycles in a sleep state, and oscillations from less than an hour to several hours periodicity in the measured physiological variables during wake state; 2) circadian rhythms; 3) non-endogenous daily rhythms shown to be imposed on top of circadian rhythms, as in work schedules; 4) weekly rhythms, or other artificial time periodicities exogenously imposed (e.g. in a hypothetical culture with 12 day “weeks,” 12 day rhythms could be used); 5) multi-day ovarian rhythms in women and spermatogenesis rhythms in men; 6) lunar rhythms (relevant for individuals living with low or no artificial lights); and 7) seasonal rhythms.

The biological rhythms are not always stationary rhythms. For example, many women experience variability in ovarian cycle length across cycles, and ultradian rhythms are not expected to occur at exactly the same time or periodicity across days even within a user. As such, signal processing techniques sufficient to quantify the frequency composition while preserving temporal resolution of these rhythms in physiological data may be used to improve detection of these rhythms, to assign phase of each rhythm to each moment in time measured, and to thereby modify adjustment models and comparisons of time intervals. The biological rhythm-adjustment models and parameters can be added in linear or non-linear combinations as appropriate to more accurately capture the dynamic physiological baselines of an individual or group of individuals.

In some aspects, the respective devices of the system 100 may support techniques for pre-charging and activating wearable devices 104, such as a ring 104, while the wearable devices 104 are packaged for shipment. For example, a ring 104 may be placed on or within a device charger that can wirelessly receive energy from a charging pad (e.g., wireless charging device) through the shipment packaging to temporarily turn on the ring 104 for updates, pre-configuration, or both, while the ring 104 is packaged. Specifically, the ring 104 may be put into a “ship mode” (e.g., turned off), positioned on or within the device charger, and packaged for shipment while positioned on the device charger. In such cases, the device charger may include a first charging component configured to wireless receive power and a second charging component configured to wirelessly transmit power. For example, the device charger may include a first contactless charging component capable of wirelessly receiving power, which may be referred to as an Rx contactless charging component (e.g., Rx inductive coil, Rx resonant charging component), and a second contactless charging component capable of wirelessly transmitting power, which may be referred to as a Tx contactless charging component (e.g., Tx inductive coil, Tx resonant charging component). As such, when the shipment packaging containing the device charger and ring 104 is placed within the threshold proximity of the charging pad (e.g., on or near the charging mat), the Rx contactless charging component of the device charger may wirelessly receive power (e.g., energy) from the charging pad through the shipment packaging and may use the power to charge a battery 210 of the ring 104 via the Tx contactless charging component. Thus, the ring 104 may be turned on (e.g., activated), thereby taking the ring 104 out of the “ship mode,” while still in the shipment packaging. As such, a user device 106 may update firmware of the ring 104, pre-configure one or more settings (e.g., parameters, user preferences/characteristics) of the ring 104, or both (e.g., via a wearable application 250).

It should be appreciated by a person skilled in the art that one or more aspects of the disclosure may be implemented in a system 100 to additionally or alternatively solve other problems than those described above. Furthermore, aspects of the disclosure may provide technical improvements to “conventional” systems or processes as described herein. However, the description and appended drawings only include example technical improvements resulting from implementing aspects of the disclosure, and accordingly do not represent all of the technical improvements provided within the scope of the claims.

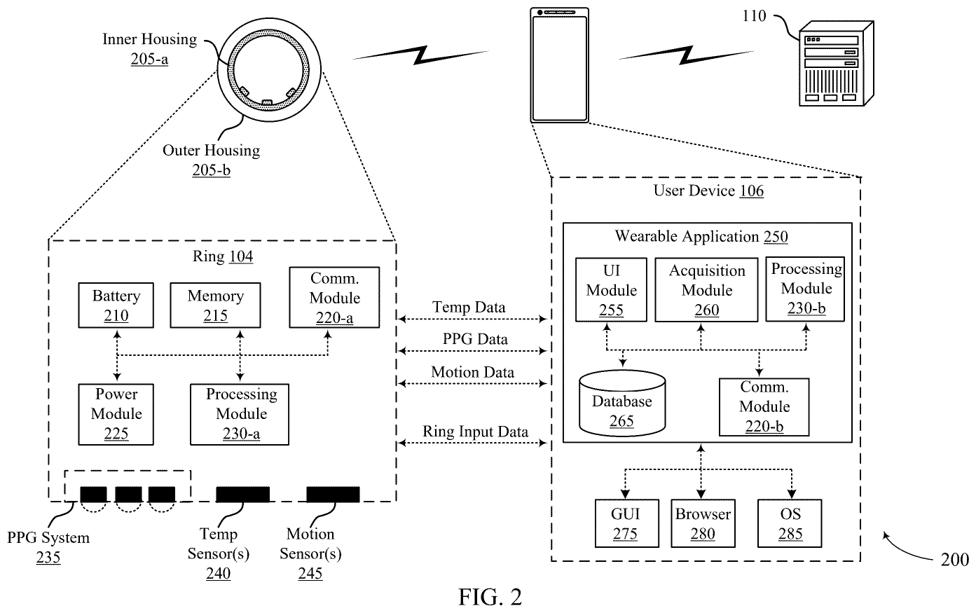

FIG. 2 illustrates an example of a system 200 that supports techniques for pre-charging wearable devices while packaged in accordance with aspects of the present disclosure. The system 200 may implement, or be implemented by, system 100. In particular, system 200 illustrates an example of a ring 104 (e.g., wearable device 104), a user device 106, and a server 110, as described with reference to FIG. 1.

In some aspects, the ring 104 may be configured to be worn around a user's finger, and may determine one or more user physiological parameters when worn around the user's finger. Example measurements and determinations may include, but are not limited to, user skin temperature, pulse waveforms, respiratory rate, heart rate, HRV, blood oxygen levels (SpO2), blood sugar levels (e.g., glucose metrics), and the like.

The system 200 further includes a user device 106 (e.g., a smartphone) in communication with the ring 104. For example, the ring 104 may be in wireless and/or wired communication with the user device 106. In some implementations, the ring 104 may send measured and processed data (e.g., temperature data, photoplethysmogram (PPG) data, motion/accelerometer data, ring input data, and the like) to the user device 106. The user device 106 may also send data to the ring 104, such as ring 104 firmware/configuration updates. The user device 106 may process data. In some implementations, the user device 106 may transmit data to the server 110 for processing and/or storage.

The ring 104 may include a housing 205 that may include an inner housing 205-a and an outer housing 205-b. In some aspects, the housing 205 of the ring 104 may store or otherwise include various components of the ring including, but not limited to, device electronics, a power source (e.g., battery 210, and/or capacitor), one or more substrates (e.g., printable circuit boards) that interconnect the device electronics and/or power source, and the like. The device electronics may include device modules (e.g., hardware/software), such as: a processing module 230-a, a memory 215, a communication module 220-a, a power module 225, and the like. The device electronics may also include one or more sensors. Example sensors may include one or more temperature sensors 240, a PPG sensor assembly (e.g., PPG system 235), and one or more motion sensors 245.

The sensors may include associated modules (not illustrated) configured to communicate with the respective components/modules of the ring 104, and generate signals associated with the respective sensors. In some aspects, each of the components/modules of the ring 104 may be communicatively coupled to one another via wired or wireless connections. Moreover, the ring 104 may include additional and/or alternative sensors or other components that are configured to collect physiological data from the user, including light sensors (e.g., LEDs), oximeters, and the like.

The ring 104 shown and described with reference to FIG. 2 is provided solely for illustrative purposes. As such, the ring 104 may include additional or alternative components as those illustrated in FIG. 2. Other rings 104 that provide functionality described herein may be fabricated. For example, rings 104 with fewer components (e.g., sensors) may be fabricated. In a specific example, a ring 104 with a single temperature sensor 240 (or other sensor), a power source, and device electronics configured to read the single temperature sensor 240 (or other sensor) may be fabricated. In another specific example, a temperature sensor 240 (or other sensor) may be attached to a user's finger (e.g., using adhesives, wraps, clamps, spring loaded clamps, etc.). In this case, the sensor may be wired to another computing device, such as a wrist worn computing device that reads the temperature sensor 240 (or other sensor). In other examples, a ring 104 that includes additional sensors and processing functionality may be fabricated.

The housing 205 may include one or more housing 205 components. The housing 205 may include an outer housing 205-b component (e.g., a shell) and an inner housing 205-a component (e.g., a molding). The housing 205 may include additional components (e.g., additional layers) not explicitly illustrated in FIG. 2. For example, in some implementations, the ring 104 may include one or more insulating layers that electrically insulate the device electronics and other conductive materials (e.g., electrical traces) from the outer housing 205-b (e.g., a metal outer housing 205-b). The housing 205 may provide structural support for the device electronics, battery 210, substrate(s), and other components. For example, the housing 205 may protect the device electronics, battery 210, and substrate(s) from mechanical forces, such as pressure and impacts. The housing 205 may also protect the device electronics, battery 210, and substrate(s) from water and/or other chemicals.

The outer housing 205-b may be fabricated from one or more materials. In some implementations, the outer housing 205-b may include a metal, such as titanium, that may provide strength and abrasion resistance at a relatively light weight. The outer housing 205-b may also be fabricated from other materials, such polymers. In some implementations, the outer housing 205-b may be protective as well as decorative.

The inner housing 205-a may be configured to interface with the user's finger. The inner housing 205-a may be formed from a polymer (e.g., a medical grade polymer) or other material. In some implementations, the inner housing 205-a may be transparent. For example, the inner housing 205-a may be transparent to light emitted by the PPG light emitting diodes (LEDs). In some implementations, the inner housing 205-a component may be molded onto the outer housing 205-b. For example, the inner housing 205-a may include a polymer that is molded (e.g., injection molded) to fit into an outer housing 205-b metallic shell.

The ring 104 may include one or more substrates (not illustrated). The device electronics and battery 210 may be included on the one or more substrates. For example, the device electronics and battery 210 may be mounted on one or more substrates. Example substrates may include one or more printed circuit boards (PCBs), such as flexible PCB (e.g., polyimide). In some implementations, the electronics/battery 210 may include surface mounted devices (e.g., surface-mount technology (SMT) devices) on a flexible PCB. In some implementations, the one or more substrates (e.g., one or more flexible PCBs) may include electrical traces that provide electrical communication between device electronics. The electrical traces may also connect the battery 210 to the device electronics.

The device electronics, battery 210, and substrates may be arranged in the ring 104 in a variety of ways. In some implementations, one substrate that includes device electronics may be mounted along the bottom of the ring 104 (e.g., the bottom half), such that the sensors (e.g., PPG system 235, temperature sensors 240, motion sensors 245, and other sensors) interface with the underside of the user's finger. In these implementations, the battery 210 may be included along the top portion of the ring 104 (e.g., on another substrate).

The various components/modules of the ring 104 represent functionality (e.g., circuits and other components) that may be included in the ring 104. Modules may include any discrete and/or integrated electronic circuit components that implement analog and/or digital circuits capable of producing the functions attributed to the modules herein. For example, the modules may include analog circuits (e.g., amplification circuits, filtering circuits, analog/digital conversion circuits, and/or other signal conditioning circuits). The modules may also include digital circuits (e.g., combinational or sequential logic circuits, memory circuits etc.).

The memory 215 (memory module) of the ring 104 may include any volatile, non-volatile, magnetic, or electrical media, such as a random access memory (RAM), read-only memory (ROM), non-volatile RAM (NVRAM), electrically-erasable programmable ROM (EEPROM), flash memory, or any other memory device. The memory 215 may store any of the data described herein. For example, the memory 215 may be configured to store data (e.g., motion data, temperature data, PPG data) collected by the respective sensors and PPG system 235. Furthermore, memory 215 may include instructions that, when executed by one or more processing circuits, cause the modules to perform various functions attributed to the modules herein. The device electronics of the ring 104 described herein are only example device electronics. As such, the types of electronic components used to implement the device electronics may vary based on design considerations.

The functions attributed to the modules of the ring 104 described herein may be embodied as one or more processors, hardware, firmware, software, or any combination thereof. Depiction of different features as modules is intended to highlight different functional aspects and does not necessarily imply that such modules must be realized by separate hardware/software components. Rather, functionality associated with one or more modules may be performed by separate hardware/software components or integrated within common hardware/software components.

The processing module 230-a of the ring 104 may include one or more processors (e.g., processing units), microcontrollers, digital signal processors, systems on a chip (SOCs), and/or other processing devices. The processing module 230-a communicates with the modules included in the ring 104. For example, the processing module 230-a may transmit/receive data to/from the modules and other components of the ring 104, such as the sensors. As described herein, the modules may be implemented by various circuit components. Accordingly, the modules may also be referred to as circuits (e.g., a communication circuit and power circuit).

The processing module 230-a may communicate with the memory 215. The memory 215 may include computer-readable instructions that, when executed by the processing module 230-a, cause the processing module 230-a to perform the various functions attributed to the processing module 230-a herein. In some implementations, the processing module 230-a (e.g., a microcontroller) may include additional features associated with other modules, such as communication functionality provided by the communication module 220-a (e.g., an integrated Bluetooth Low Energy transceiver) and/or additional onboard memory 215.

The communication module 220-a may include circuits that provide wireless and/or wired communication with the user device 106 (e.g., communication module 220-b of the user device 106). In some implementations, the communication modules 220-a, 220-b may include wireless communication circuits, such as Bluetooth circuits and/or Wi-Fi circuits. In some implementations, the communication modules 220-a, 220-b can include wired communication circuits, such as Universal Serial Bus (USB) communication circuits. Using the communication module 220-a, the ring 104 and the user device 106 may be configured to communicate with each other. The processing module 230-a of the ring may be configured to transmit/receive data to/from the user device 106 via the communication module 220-a. Example data may include, but is not limited to, motion data, temperature data, pulse waveforms, heart rate data, HRV data, PPG data, and status updates (e.g., charging status, battery charge level, and/or ring 104 configuration settings). The processing module 230-a of the ring may also be configured to receive updates (e.g., software/firmware updates) and data from the user device 106.

The ring 104 may include a battery 210 (e.g., a rechargeable battery 210). An example battery 210 may include a Lithium-Ion or Lithium-Polymer type battery 210, although a variety of battery 210 options are possible. The battery 210 may be wirelessly charged. In some implementations, the ring 104 may include a power source other than the battery 210, such as a capacitor. The power source (e.g., battery 210 or capacitor) may have a curved geometry that matches the curve of the ring 104. In some aspects, a charger or other power source may include additional sensors that may be used to collect data in addition to, or that supplements, data collected by the ring 104 itself. Moreover, a charger or other power source for the ring 104 may function as a user device 106, in which case the charger or other power source for the ring 104 may be configured to receive data from the ring 104, store and/or process data received from the ring 104, and communicate data between the ring 104 and the servers 110.

In some aspects, the ring 104 includes a power module 225 that may control charging of the battery 210. For example, the power module 225 may interface with an external wireless charger that charges the battery 210 when interfaced with the ring 104. The charger may include a datum structure that mates with a ring 104 datum structure to create a specified orientation with the ring 104 during charging. The power module 225 may also regulate voltage(s) of the device electronics, regulate power output to the device electronics, and monitor the state of charge of the battery 210. In some implementations, the battery 210 may include a protection circuit module (PCM) that protects the battery 210 from high current discharge, over voltage during charging, and under voltage during discharge. The power module 225 may also include electro-static discharge (ESD) protection.

The one or more temperature sensors 240 may be electrically coupled to the processing module 230-a. The temperature sensor 240 may be configured to generate a temperature signal (e.g., temperature data) that indicates a temperature read or sensed by the temperature sensor 240. The processing module 230-a may determine a temperature of the user in the location of the temperature sensor 240. For example, in the ring 104, temperature data generated by the temperature sensor 240 may indicate a temperature of a user at the user's finger (e.g., skin temperature). In some implementations, the temperature sensor 240 may contact the user's skin. In other implementations, a portion of the housing 205 (e.g., the inner housing 205-a) may form a barrier (e.g., a thin, thermally conductive barrier) between the temperature sensor 240 and the user's skin. In some implementations, portions of the ring 104 configured to contact the user's finger may have thermally conductive portions and thermally insulative portions. The thermally conductive portions may conduct heat from the user's finger to the temperature sensors 240. The thermally insulative portions may insulate portions of the ring 104 (e.g., the temperature sensor 240) from ambient temperature.

In some implementations, the temperature sensor 240 may generate a digital signal (e.g., temperature data) that the processing module 230-a may use to determine the temperature. As another example, in cases where the temperature sensor 240 includes a passive sensor, the processing module 230-a (or a temperature sensor 240 module) may measure a current/voltage generated by the temperature sensor 240 and determine the temperature based on the measured current/voltage. Example temperature sensors 240 may include a thermistor, such as a negative temperature coefficient (NTC) thermistor, or other types of sensors including resistors, transistors, diodes, and/or other electrical/electronic components.

The processing module 230-a may sample the user's temperature over time. For example, the processing module 230-a may sample the user's temperature according to a sampling rate. An example sampling rate may include one sample per second, although the processing module 230-a may be configured to sample the temperature signal at other sampling rates that are higher or lower than one sample per second. In some implementations, the processing module 230-a may sample the user's temperature continuously throughout the day and night. Sampling at a sufficient rate (e.g., one sample per second) throughout the day may provide sufficient temperature data for analysis described herein.

The processing module 230-a may store the sampled temperature data in memory 215. In some implementations, the processing module 230-a may process the sampled temperature data. For example, the processing module 230-a may determine average temperature values over a period of time. In one example, the processing module 230-a may determine an average temperature value each minute by summing all temperature values collected over the minute and dividing by the number of samples over the minute. In a specific example where the temperature is sampled at one sample per second, the average temperature may be a sum of all sampled temperatures for one minute divided by sixty seconds. The memory 215 may store the average temperature values over time. In some implementations, the memory 215 may store average temperatures (e.g., one per minute) instead of sampled temperatures in order to conserve memory 215.

The sampling rate, which may be stored in memory 215, may be configurable. In some implementations, the sampling rate may be the same throughout the day and night. In other implementations, the sampling rate may be changed throughout the day/night. In some implementations, the ring 104 may filter/reject temperature readings, such as large spikes in temperature that are not indicative of physiological changes (e.g., a temperature spike from a hot shower). In some implementations, the ring 104 may filter/reject temperature readings that may not be reliable due to other factors, such as excessive motion during exercise (e.g., as indicated by a motion sensor 245).

The ring 104 (e.g., communication module) may transmit the sampled and/or average temperature data to the user device 106 for storage and/or further processing. The user device 106 may transfer the sampled and/or average temperature data to the server 110 for storage and/or further processing.

Although the ring 104 is illustrated as including a single temperature sensor 240, the ring 104 may include multiple temperature sensors 240 in one or more locations, such as arranged along the inner housing 205-a near the user's finger. In some implementations, the temperature sensors 240 may be stand-alone temperature sensors 240. Additionally, or alternatively, one or more temperature sensors 240 may be included with other components (e.g., packaged with other components), such as with the accelerometer and/or processor.

The processing module 230-a may acquire and process data from multiple temperature sensors 240 in a similar manner described with respect to a single temperature sensor 240. For example, the processing module 230 may individually sample, average, and store temperature data from each of the multiple temperature sensors 240. In other examples, the processing module 230-a may sample the sensors at different rates and average/store different values for the different sensors. In some implementations, the processing module 230-a may be configured to determine a single temperature based on the average of two or more temperatures determined by two or more temperature sensors 240 in different locations on the finger.

The temperature sensors 240 on the ring 104 may acquire distal temperatures at the user's finger (e.g., any finger). For example, one or more temperature sensors 240 on the ring 104 may acquire a user's temperature from the underside of a finger or at a different location on the finger. In some implementations, the ring 104 may continuously acquire distal temperature (e.g., at a sampling rate). Although distal temperature measured by a ring 104 at the finger is described herein, other devices may measure temperature at the same/different locations. In some cases, the distal temperature measured at a user's finger may differ from the temperature measured at a user's wrist or other external body location. Additionally, the distal temperature measured at a user's finger (e.g., a “shell” temperature) may differ from the user's core temperature. As such, the ring 104 may provide a useful temperature signal that may not be acquired at other internal/external locations of the body. In some cases, continuous temperature measurement at the finger may capture temperature fluctuations (e.g., small or large fluctuations) that may not be evident in core temperature. For example, continuous temperature measurement at the finger may capture minute-to-minute or hour-to-hour temperature fluctuations that provide additional insight that may not be provided by other temperature measurements elsewhere in the body.

The ring 104 may include a PPG system 235. The PPG system 235 may include one or more optical transmitters that transmit light. The PPG system 235 may also include one or more optical receivers that receive light transmitted by the one or more optical transmitters. An optical receiver may generate a signal (hereinafter “PPG” signal) that indicates an amount of light received by the optical receiver. The optical transmitters may illuminate a region of the user's finger. The PPG signal generated by the PPG system 235 may indicate the perfusion of blood in the illuminated region. For example, the PPG signal may indicate blood volume changes in the illuminated region caused by a user's pulse pressure. The processing module 230-a may sample the PPG signal and determine a user's pulse waveform based on the PPG signal. The processing module 230-a may determine a variety of physiological parameters based on the user's pulse waveform, such as a user's respiratory rate, heart rate, HRV, oxygen saturation, and other circulatory parameters.

In some implementations, the PPG system 235 may be configured as a reflective PPG system 235 where the optical receiver(s) receive transmitted light that is reflected through the region of the user's finger. In some implementations, the PPG system 235 may be configured as a transmissive PPG system 235 where the optical transmitter(s) and optical receiver(s) are arranged opposite to one another, such that light is transmitted directly through a portion of the user's finger to the optical receiver(s).

The number and ratio of transmitters and receivers included in the PPG system 235 may vary. Example optical transmitters may include light-emitting diodes (LEDs). The optical transmitters may transmit light in the infrared spectrum and/or other spectrums. Example optical receivers may include, but are not limited to, photosensors, phototransistors, and photodiodes. The optical receivers may be configured to generate PPG signals in response to the wavelengths received from the optical transmitters. The location of the transmitters and receivers may vary. Additionally, a single device may include reflective and/or transmissive PPG systems 235.

The PPG system 235 illustrated in FIG. 2 may include a reflective PPG system 235 in some implementations. In these implementations, the PPG system 235 may include a centrally located optical receiver (e.g., at the bottom of the ring 104) and two optical transmitters located on each side of the optical receiver. In this implementation, the PPG system 235 (e.g., optical receiver) may generate the PPG signal based on light received from one or both of the optical transmitters. In other implementations, other placements, combinations, and/or configurations of one or more optical transmitters and/or optical receivers are contemplated.

The processing module 230-a may control one or both of the optical transmitters to transmit light while sampling the PPG signal generated by the optical receiver. In some implementations, the processing module 230-a may cause the optical transmitter with the stronger received signal to transmit light while sampling the PPG signal generated by the optical receiver. For example, the selected optical transmitter may continuously emit light while the PPG signal is sampled at a sampling rate (e.g., 250 Hz).

Sampling the PPG signal generated by the PPG system 235 may result in a pulse waveform that may be referred to as a “PPG.” The pulse waveform may indicate blood pressure vs time for multiple cardiac cycles. The pulse waveform may include peaks that indicate cardiac cycles. Additionally, the pulse waveform may include respiratory induced variations that may be used to determine respiration rate. The processing module 230-a may store the pulse waveform in memory 215 in some implementations. The processing module 230-a may process the pulse waveform as it is generated and/or from memory 215 to determine user physiological parameters described herein.

The processing module 230-a may determine the user's heart rate based on the pulse waveform. For example, the processing module 230-a may determine heart rate (e.g., in beats per minute) based on the time between peaks in the pulse waveform. The time between peaks may be referred to as an interbeat interval (IBI). The processing module 230-a may store the determined heart rate values and IBI values in memory 215.

The processing module 230-a may determine HRV over time. For example, the processing module 230-a may determine HRV based on the variation in the IBIs. The processing module 230-a may store the HRV values over time in the memory 215. Moreover, the processing module 230-a may determine the user's respiratory rate over time. For example, the processing module 230-a may determine respiratory rate based on frequency modulation, amplitude modulation, or baseline modulation of the user's IBI values over a period of time. Respiratory rate may be calculated in breaths per minute or as another breathing rate (e.g., breaths per 30 seconds). The processing module 230-a may store user respiratory rate values over time in the memory 215.

The ring 104 may include one or more motion sensors 245, such as one or more accelerometers (e.g., 6-D accelerometers) and/or one or more gyroscopes (gyros). The motion sensors 245 may generate motion signals that indicate motion of the sensors. For example, the ring 104 may include one or more accelerometers that generate acceleration signals that indicate acceleration of the accelerometers. As another example, the ring 104 may include one or more gyro sensors that generate gyro signals that indicate angular motion (e.g., angular velocity) and/or changes in orientation. The motion sensors 245 may be included in one or more sensor packages. An example accelerometer/gyro sensor is a Bosch BM1160 inertial micro electro-mechanical system (MEMS) sensor that may measure angular rates and accelerations in three perpendicular axes.

The processing module 230-a may sample the motion signals at a sampling rate (e.g., 50 Hz) and determine the motion of the ring 104 based on the sampled motion signals. For example, the processing module 230-a may sample acceleration signals to determine acceleration of the ring 104. As another example, the processing module 230-a may sample a gyro signal to determine angular motion. In some implementations, the processing module 230-a may store motion data in memory 215. Motion data may include sampled motion data as well as motion data that is calculated based on the sampled motion signals (e.g., acceleration and angular values).

The ring 104 may store a variety of data described herein. For example, the ring 104 may store temperature data, such as raw sampled temperature data and calculated temperature data (e.g., average temperatures). As another example, the ring 104 may store PPG signal data, such as pulse waveforms and data calculated based on the pulse waveforms (e.g., heart rate values, IBI values, HRV values, and respiratory rate values). The ring 104 may also store motion data, such as sampled motion data that indicates linear and angular motion.

The ring 104, or other computing device, may calculate and store additional values based on the sampled/calculated physiological data. For example, the processing module 230 may calculate and store various metrics, such as sleep metrics (e.g., a Sleep Score), activity metrics, and readiness metrics. In some implementations, additional values/metrics may be referred to as “derived values.” The ring 104, or other computing/wearable device, may calculate a variety of values/metrics with respect to motion. Example derived values for motion data may include, but are not limited to, motion count values, regularity values, intensity values, metabolic equivalence of task values (METs), and orientation values. Motion counts, regularity values, intensity values, and METs may indicate an amount of user motion (e.g., velocity/acceleration) over time. Orientation values may indicate how the ring 104 is oriented on the user's finger and if the ring 104 is worn on the left hand or right hand.

In some implementations, motion counts and regularity values may be determined by counting a number of acceleration peaks within one or more periods of time (e.g., one or more 30 second to 1 minute periods). Intensity values may indicate a number of movements and the associated intensity (e.g., acceleration values) of the movements. The intensity values may be categorized as low, medium, and high, depending on associated threshold acceleration values. METs may be determined based on the intensity of movements during a period of time (e.g., 30 seconds), the regularity/irregularity of the movements, and the number of movements associated with the different intensities.

In some implementations, the processing module 230-a may compress the data stored in memory 215. For example, the processing module 230-a may delete sampled data after making calculations based on the sampled data. As another example, the processing module 230-a may average data over longer periods of time in order to reduce the number of stored values. In a specific example, if average temperatures for a user over one minute are stored in memory 215, the processing module 230-a may calculate average temperatures over a five minute time period for storage, and then subsequently erase the one minute average temperature data. The processing module 230-a may compress data based on a variety of factors, such as the total amount of used/available memory 215 and/or an elapsed time since the ring 104 last transmitted the data to the user device 106.

Although a user's physiological parameters may be measured by sensors included on a ring 104, other devices may measure a user's physiological parameters. For example, although a user's temperature may be measured by a temperature sensor 240 included in a ring 104, other devices may measure a user's temperature. In some examples, other wearable devices (e.g., wrist devices) may include sensors that measure user physiological parameters. Additionally, medical devices, such as external medical devices (e.g., wearable medical devices) and/or implantable medical devices, may measure a user's physiological parameters. One or more sensors on any type of computing device may be used to implement the techniques described herein.

The physiological measurements may be taken continuously throughout the day and/or night. In some implementations, the physiological measurements may be taken during portions of the day and/or portions of the night. In some implementations, the physiological measurements may be taken in response to determining that the user is in a specific state, such as an active state, resting state, and/or a sleeping state. For example, the ring 104 can make physiological measurements in a resting/sleep state in order to acquire cleaner physiological signals. In one example, the ring 104 or other device/system may detect when a user is resting and/or sleeping and acquire physiological parameters (e.g., temperature) for that detected state. The devices/systems may use the resting/sleep physiological data and/or other data when the user is in other states in order to implement the techniques of the present disclosure.

In some implementations, as described previously herein, the ring 104 may be configured to collect, store, and/or process data, and may transfer any of the data described herein to the user device 106 for storage and/or processing. In some aspects, the user device 106 includes a wearable application 250, an operating system (OS) 285, a web browser application (e.g., web browser 280), one or more additional applications, and a GUI 275. The user device 106 may further include other modules and components, including sensors, audio devices, haptic feedback devices, and the like. The wearable application 250 may include an example of an application (e.g., “app”) that may be installed on the user device 106. The wearable application 250 may be configured to acquire data from the ring 104, store the acquired data, and process the acquired data as described herein. For example, the wearable application 250 may include a user interface (UI) module 255, an acquisition module 260, a processing module 230-b, a communication module 220-b, and a storage module (e.g., database 265) configured to store application data.

In some cases, the wearable device 104 and the user device 106 may be included within (or make up) the same device. For example, in some cases, the wearable device 104 may be configured to execute the wearable application 250, and may be configured to display data via the GUI 275.

The various data processing operations described herein may be performed by the ring 104, the user device 106, the servers 110, or any combination thereof. For example, in some cases, data collected by the ring 104 may be pre-processed and transmitted to the user device 106. In this example, the user device 106 may perform some data processing operations on the received data, may transmit the data to the servers 110 for data processing, or both. For instance, in some cases, the user device 106 may perform processing operations that require relatively low processing power and/or operations that require a relatively low latency, whereas the user device 106 may transmit the data to the servers 110 for processing operations that require relatively high processing power and/or operations that may allow relatively higher latency.

In some aspects, the ring 104, user device 106, and server 110 of the system 200 may be configured to evaluate sleep patterns for a user. In particular, the respective components of the system 200 may be used to collect data from a user via the ring 104, and generate one or more scores (e.g., Sleep Score, Readiness Score) for the user based on the collected data. For example, as noted previously herein, the ring 104 of the system 200 may be worn by a user to collect data from the user, including temperature, heart rate, HRV, and the like. Data collected by the ring 104 may be used to determine when the user is asleep in order to evaluate the user's sleep for a given “sleep day.” In some aspects, scores may be calculated for the user for each respective sleep day, such that a first sleep day is associated with a first set of scores, and a second sleep day is associated with a second set of scores. Scores may be calculated for each respective sleep day based on data collected by the ring 104 during the respective sleep day. Scores may include, but are not limited to, Sleep Scores, Readiness Scores, and the like.

In some cases, “sleep days” may align with the traditional calendar days, such that a given sleep day runs from midnight to midnight of the respective calendar day. In other cases, sleep days may be offset relative to calendar days. For example, sleep days may run from 6:00 pm (18:00) of a calendar day until 6:00 pm (18:00) of the subsequent calendar day. In this example, 6:00 pm may serve as a “cut-off time,” where data collected from the user before 6:00 pm is counted for the current sleep day, and data collected from the user after 6:00 pm is counted for the subsequent sleep day. Due to the fact that most individuals sleep the most at night, offsetting sleep days relative to calendar days may enable the system 200 to evaluate sleep patterns for users in such a manner that is consistent with their sleep schedules. In some cases, users may be able to selectively adjust (e.g., via the GUI) a timing of sleep days relative to calendar days so that the sleep days are aligned with the duration of time that the respective users typically sleep.

In some implementations, each overall score for a user for each respective day (e.g., Sleep Score, Readiness Score) may be determined/calculated based on one or more “contributors,” “factors,” or “contributing factors.” For example, a user's overall Sleep Score may be calculated based on a set of contributors, including: total sleep, efficiency, restfulness, REM sleep, deep sleep, latency, timing, or any combination thereof. The Sleep Score may include any quantity of contributors. The “total sleep” contributor may refer to the sum of all sleep periods of the sleep day. The “efficiency” contributor may reflect the percentage of time spent asleep compared to time spent awake while in bed, and may be calculated using the efficiency average of long sleep periods (e.g., primary sleep period) of the sleep day, weighted by a duration of each sleep period. The “restfulness” contributor may indicate how restful the user's sleep is, and may be calculated using the average of all sleep periods of the sleep day, weighted by a duration of each period. The restfulness contributor may be based on a “wake up count” (e.g., sum of all the wake-ups (when user wakes up) detected during different sleep periods), excessive movement, and a “got up count” (e.g., sum of all the got-ups (when user gets out of bed) detected during the different sleep periods).

The “REM sleep” contributor may refer to a sum total of REM sleep durations across all sleep periods of the sleep day including REM sleep. Similarly, the “deep sleep” contributor may refer to a sum total of deep sleep durations across all sleep periods of the sleep day including deep sleep. The “latency” contributor may signify how long (e.g., average, median, longest) the user takes to go to sleep, and may be calculated using the average of long sleep periods throughout the sleep day, weighted by a duration of each period and the number of such periods (e.g., consolidation of a given sleep stage or sleep stages may be its own contributor or weight other contributors). Lastly, the “timing” contributor may refer to a relative timing of sleep periods within the sleep day and/or calendar day, and may be calculated using the average of all sleep periods of the sleep day, weighted by a duration of each period.

By way of another example, a user's overall Readiness Score may be calculated based on a set of contributors, including: sleep, sleep balance, heart rate, HRV balance, recovery index, temperature, activity, activity balance, or any combination thereof. The Readiness Score may include any quantity of contributors. The “sleep” contributor may refer to the combined Sleep Score of all sleep periods within the sleep day. The “sleep balance” contributor may refer to a cumulative duration of all sleep periods within the sleep day. In particular, sleep balance may indicate to a user whether the sleep that the user has been getting over some duration of time (e.g., the past two weeks) is in balance with the user's needs. Typically, adults need 7-9 hours of sleep a night to stay healthy, alert, and to perform at their best both mentally and physically. However, it is normal to have an occasional night of bad sleep, so the sleep balance contributor takes into account long-term sleep patterns to determine whether each user's sleep needs are being met. The “resting heart rate” contributor may indicate a lowest heart rate from the longest sleep period of the sleep day (e.g., primary sleep period) and/or the lowest heart rate from naps occurring after the primary sleep period.

Continuing with reference to the “contributors” (e.g., factors, contributing factors) of the Readiness Score, the “HRV balance” contributor may indicate a highest HRV average from the primary sleep period and the naps happening after the primary sleep period. The HRV balance contributor may help users keep track of their recovery status by comparing their HRV trend over a first time period (e.g., two weeks) to an average HRV over some second, longer time period (e.g., three months). The “recovery index” contributor may be calculated based on the longest sleep period. Recovery index measures how long it takes for a user's resting heart rate to stabilize during the night. A sign of a very good recovery is that the user's resting heart rate stabilizes during the first half of the night, at least six hours before the user wakes up, leaving the body time to recover for the next day. The “body temperature” contributor may be calculated based on the longest sleep period (e.g., primary sleep period) or based on a nap happening after the longest sleep period if the user's highest temperature during the nap is at least 0.5° C. higher than the highest temperature during the longest period. In some aspects, the ring may measure a user's body temperature while the user is asleep, and the system 200 may display the user's average temperature relative to the user's baseline temperature. If a user's body temperature is outside of their normal range (e.g., clearly above or below 0.0), the body temperature contributor may be highlighted (e.g., go to a “Pay attention” state) or otherwise generate an alert for the user.

In some aspects, the system 200 may support techniques for pre-charging and activating wearable devices 104, such as a ring 104, while the wearable devices 104 are packaged for shipment. For example, a ring 104 may be placed on or within a device charger that can wirelessly receive energy from a charging pad (e.g., wireless charging device) through the shipment packaging to temporarily turn on the ring 104 for updates, pre-configuration, or both, while the ring 104 is packaged. Specifically, the ring 104 may be put into a “ship mode” (e.g., turned off), positioned on or within the device charger, and packaged for shipment while positioned on the device charger. In such cases, the device charger may include a first charging component configured to wireless receive power and a second charging component configured to wirelessly transmit power. For example, the device charger may include a first contactless charging component capable of wirelessly receiving power, which may be referred to as an Rx contactless charging component (e.g., Rx inductive coil, Rx resonant charging component), and a second contactless charging component capable of wirelessly transmitting power, which may be referred to as a Tx contactless charging component (e.g., Tx inductive coil, Tx resonant charging component). As such, when the shipment packaging containing the device charger and ring 104 is placed within the threshold proximity of the charging pad (e.g., on or near the charging mat), the Rx contactless charging component of the device charger may wirelessly receive power (e.g., energy) from the charging pad through the shipment packaging and may use the power to charge the ring 104 via the Tx contactless charging component. Thus, the ring 104 may be turned on (e.g., activated), thereby taking the ring 104 out of the “ship mode,” while still in the shipment packaging. As such, a user device 106 may update firmware of the ring 104, pre-configure one or more settings (e.g., parameters) of the ring 104, or both.

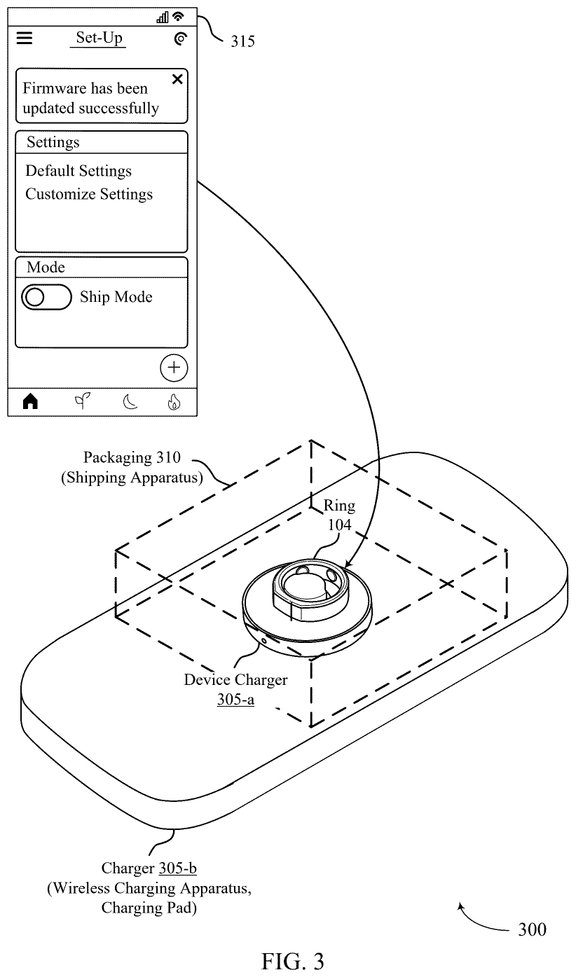

FIG. 3 shows an example of a system 300 that supports techniques for pre-charging wearable devices while packaged in accordance with aspects of the present disclosure. The system 300 may include, at least, a ring 104, a device charger 305-a, and a charger 305-b.

Many wearable devices 104, such as the ring 104, are typically battery-powered, such as via a lithium battery. In some cases, a battery used to power the ring 104 may be damaged or destroyed if the battery is left fully drained for an extended period of time. As such, to protect the battery during shipment, the ring 104 may be pre-charged to some level (e.g., 20-80%) and turned off during shipment (e.g., turned to a “ship mode” after manufacturing and testing). However, many wearable devices 104, such as the ring 104, do not have physical on and off buttons. Thus, in order to turn the ring 104 on (e.g., transition the ring 104 out of “ship mode”), a user 102 may need to remove the ring 104 and the device charger 305-a (e.g., ring device charger 305-a, wearable device charger 305-a) from shipment packaging (e.g., a box), which may be referred to as packaging 310, plug the device charger 305-a in, place the ring 104 on or within the device charger 305-a to transition the ring 104 out of “ship mode,” and potentially wait for one or more updates to occur and/or for one or more user settings to be applied prior using the ring 104. This process may result in increased latency that decreases user experience. This latency issue may further be compounded in bulk distribution cases where rings 104 are shipped in bulk (e.g., research studies, military applications, enterprise customers, etc.) and where an administrative user 102 may be required to unpackage, charge/activate, update/configure, then repackage hundreds of rings 104 prior to distributing the rings 104 to end users 102.

Thus, to improve user experience and reduce latency, specifically in bulk distribution scenarios, techniques described herein may support pre-charging and activating of wearable devices 104, such as the ring 104, while the wearable devices 104 are packaged for shipment. For example, the ring 104 may be placed on or within the device charger 305-a, where the device charger 305-a is capable of receiving energy from the charger 305-b (e.g., wireless charging apparatus, wireless charging pad) through the packaging 310 to temporarily turn on the ring 104 for updates, pre-configuration, or both, while the ring 104 is in the packaging 310. Specifically, the ring 104 may be put into a “ship mode” (e.g., turned off), positioned on or within the device charger 305-a, and packaged for shipment (e.g., in the packaging 310) while positioned on or within the device charger 305-a. In some cases, as depicted in FIG. 3, the device charger 305-a may include a charging post, such that an inner circumference of the ring 104 may be placed around the charging post to charge the ring 104. In some other cases, the device charger 305-a may include a cavity, such that at least a portion of the ring 104 may be placed in the cavity to charge the ring 104 (e.g., among other device charger 305-a configurations or designs). Additionally, the ring 104 may be packaged in such a manner that movement of the ring 104 on or within the device charger 305-a may be limited (e.g., restricted to a threshold range of movement) to prevent damage during shipment due to contact between the ring 104 and the device charger 305-a. For example, a thin layer of foam (or other insulating/protective material) may be placed between the ring 104 and the charging post of the device charger 305-a, such that the foam prevents the ring 104 from moving without impacting (e.g., inhibiting) charging of the ring 104 by the device charger 305-a.

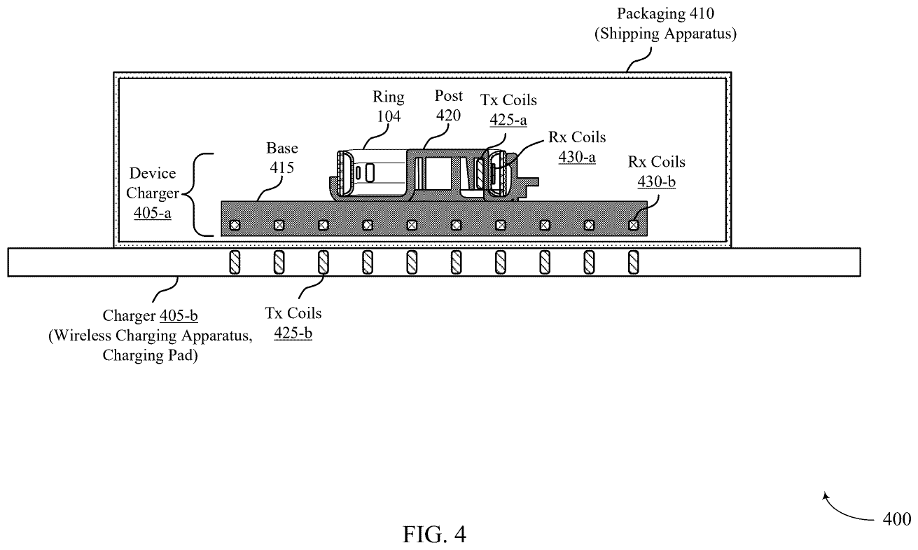

In some cases, the device charger 305-a may include a first charging component (e.g., a first contactless charging component) configured to wireless receive power and a second charging component (e.g., a second contactless charging component) configured to wirelessly transmit power. For example, the device charger 305-a may include a first inductive coil (and/or first resonant charging component) capable of wirelessly receiving power from the charger 305-b, which may be referred to as an Rx inductive coil, and a second inductive coil (and/or second resonant charging component) capable of wirelessly transmitting power to the ring 104, which may be referred to as a Tx inductive coil, as described further with reference to FIG. 4. As such, when the packaging 310 containing the device charger 305-a and ring 104 is placed within a threshold proximity of the charger 305-b (e.g., on or near the charging pad), the Rx inductive coil of the device charger 305-a may wirelessly receive power (e.g., energy) from the charger 305-b through the packaging 310 and may use the power to charge the wearable ring device via the Tx inductive coil.

Thus, the ring 104 may be turned on (e.g., activated), thereby taking the ring 104 out of the “ship mode,” while still in the packaging 310. As such, a user device 106 may update firmware of the ring 104, pre-configure one or more settings (e.g., parameters) of the ring 104, or both, while the ring 104 is still within the packaging 310. That is, after turning on the ring 104 and exiting the “ship mode,” the ring 104 may begin communicating with the user device 106. In such cases, the user device 106 may display, to a user 102, an application page 315 with a series of prompts to enable the user 102 to update the firmware of the ring 104, pre-configure the one or more settings of the ring 104, or both. For example, as depicted in FIG. 3, the user 102 may select to update the firmware of the ring 104 and may receive a message indicating that the firmware update was successful. Additionally, or alternatively, the user 102 may update one or more settings of the ring 104. For example, the user 102 may input one or more characteristics associated with the user 102, such as a name of the user 102, an age of the user 102, a sex of the user 102, a weight of the user 102, or the like thereof. Additionally, or alternatively, the user 102 may select one or more settings for the ring 104, such as pre-emptively putting the ring 104 in a rest mode, setting a notification setting of the ring 104, or the like thereof.

In some cases, the ring 104 may be unpackaged by the user 102 within a threshold duration after updating, pre-configuring, or both, such that the ring 104 may be left on (e.g., activated, in an active state) after updating, pre-configuring, or both, and can be worn and used by the user 102 immediately after unpackaging the ring 104. For example, a first user 102 may purchase the ring 104 for a second user 102 who is the intended user 102 of the ring 104. As such, to prepare the ring 104 to be gifted to the second user 102, the first user 102 may update/pre-configure the ring 104 a day before gifting the ring 104 to the user 102. As such, the second user 102 may begin using the ring 104 immediately after removing the ring 104 from the packaging 310.

In some other cases, the ring 104 may be unpackaged by the user 102 outside of (e.g., exceeding, beyond) the threshold duration, such that leaving the ring 104 on may risk damaging the battery. In such cases, after completion of updates/pre-configuration, the user device 106 (e.g., an application associated with the ring 104 on the user device 106) may be used to return to the ring 104 to the “ship mode” to protect the battery life until the ring 104 is removed from the shipment packaging 310 for use by the user 102 (e.g., or activated for a second time while still in the packaging 310). For example, a slider on the application page 315 may enable the user 102 to transition the ring 104 back into the “ship mode.” Though described as a “ship mode,” enabling of the “ship mode” is not limited to shipment scenarios and may be turned on and off at any time. That is, the “ship mode” may merely refer to a mode in which the ring 104 is turned off. For example, the user 102 may be aware that they will not be able to use the ring 104 for an extended period of time (e.g., exceeding the threshold duration), such as the user 102 entering a remote setting without power, and may transition the ring 104 to the “ship mode” to conserve life of the battery while not being used.

Though described in the context of Rx inductive coils and Tx inductive coils, this is not to be regarded as a limitation of the present disclosure. In this regard, any charging mechanism (e.g., wired or wireless) may be used to transfer energy from the charger 305-b to the device charger 305-a. For example, the first charging component and the second charging component may include resonant charging components, such that the first charging component includes one or more Rx resonant charging coils and the second charging component includes one or more Tx resonant charging coils. In such cases, an efficiency of energy transfer (e.g., or ability to transfer energy) between the one or more Rx resonant charging coils and the one or more Tx resonant charging coils may not depend on an orientation of the one or more Rx resonant charging coils relative to the one or more Tx resonant charging coils (e.g., or visa-versa). Additionally, or alternatively, the one or more Rx resonant charging coils and the one or more Tx resonant charging coils may be capable of wirelessly transferring energy over a greater distance than the Rx inductive coils and the Tx inductive coils. In other words, the first charging component and the second charging component may be examples of contact-based charging components, contactless charging components, or a combination of both.

Further, though described in the context of a charger 305-b, this is not to be regarded as a limitation of the present disclosure. In this regard, any device capable of supplying, transmitting, or transferring energy may be considered a charger 305-b, including but not limited to a user device 106, a charging pad, a charging mat, or the like thereof.

FIG. 4 shows an example of a system 400 that supports techniques for pre-charging wearable devices while packaged in accordance with aspects of the present disclosure. The system 400 may include, at least, a ring 104, a device charger 405-a, and a charger 405-b.

As described previously, the devices of the system 400 may support pre-charging and activating of wearable devices 104, such as the ring 104, while the wearable devices 104 are packaged for shipment. For example, the ring 104 may be placed on or within the device charger 405-a, where the device charger 405-a is capable of receiving energy from the charger 405-b (e.g., wireless charging apparatus, wireless charging pad) through packaging 410 to temporarily turn on the ring 104 for updates, pre-configuration, or both, while the ring 104 is in the packaging 410, as described with reference to FIG. 3.

Specifically, the ring 104 may be put into a “ship mode” (e.g., turned off), positioned on or within the device charger 405-a, and packaged for shipment (e.g., in the packaging 410) while positioned on or within the device charger 305-a. Though depicted as a box, the packaging 410 is not limited to a box and may include any means or structures used to house at least the ring 104 and the charger 405-b (e.g., for shipment or other purposes). For example, the packaging 410 may include, but is not limited to, a box, an envelope, a bag, etc. In some cases, as depicted in FIG. 4, the device charger 405-a may include a post 420 (e.g., charging post), such that the ring 104 may be placed around the post 420 to charge the ring 104. In other words, one or more first charging components (e.g., one or more first contactless charging components, one or more first contact-based charging components, or both) of the ring 104 may wirelessly receive energy from one or more second charging components (e.g., one or more second contactless charging components, one or more second contact-based charging components, or both) of the device charger 405-a. For example, the ring 104 may include one or more Rx coils 430-a (e.g., Rx inductive coils) wrapped radially around the ring 104 and the device charger 405-a may include one or more Tx coils 425-a (e.g., Tx inductive coils) wrapped radially around the post 420, such that energy may be wirelessly transferred from the one or more Tx coils 425-a to the one or more Rx coils 430-a when the ring 104 is placed on the post 420 (e.g., the one or more Rx coils 430-a are within a first threshold proximity of the one or more Tx coils 425-a).

Additionally, the ring 104 may be packaged in such a manner that movement of the ring 104 on or within the device charger 405-a may be limited to prevent damage during shipment due to contact between the ring 104 and the device charger 405-a. For example, a thin layer of foam (or other protective material) may be placed between the ring 104 and the post 420, such that the foam prevents the ring 104 from moving without impacting (e.g., inhibiting) charging of the ring 104 by the device charger 405-a. That is, the foam may secure (e.g., stabilize) the ring 104 on the device charger 405-a without preventing the one or more Tx coils 425-a from transferring energy to the one or more Rx coils 430-a.

Additionally, or alternatively, the device charger 405-a may be positioned in the packaging 410 in such a manner that movement of the device charger 405-a within the packaging 410 is limited, for example, to maintain an alignment between the device charger 405-a and the packaging 410, and further with the charger 405-b (e.g., when being charged). In other words, the packaging 410, the device charger 405-a, or both, may include one or more components configured to maintain a position of the device charger 405-a within the packaging 410 (e.g., a box) to prevent, or otherwise restrict, movement (e.g., rotation) of the device charger 405-a within the packaging 410 during transit, during charging via the device charger 405-b, or both.

Additionally, the device charger 405-a may include one or more charging components capable of wirelessly receiving energy from one or more charging components of the charger 405-b (e.g., wireless charging apparatus, charging pad). For example, the device charger 405-a may include one or more Rx coils 430-b in a base 415 of the device charger 405-a and the charger 405-b may include one or more Tx coils 425-b, such that energy may be wirelessly transferred from the one or more Tx coils 425-b to the one or more Rx coils 430-b when the packaging 410 is placed on or near the charger 405-b (e.g., the one or more Rx coils 430-b are within a second threshold proximity of the one or more Tx coils 425-a). In some cases, a thickness of the packaging 410 may be designed to support wireless energy transfer between the charger 405-b and the device charger 405-a.

In some cases, the one or more Rx coils 430-b may directly transfer energy received from the one or more Tx coils 425-b to the one or more Tx coils 425-a. In some other examples, the device charger 405-a may include a battery (or other storage device, such as a capacitor) between the one or more Rx coils 430-b and the one or more Tx coils 425-a, such that the one or more Rx coils 430-b may transfer energy (e.g., power) to the battery and the one or more Tx coils 425-a may pull (e.g., draw, receive) energy from the battery. In other words, energy received by the one or more Rx coils 430-b may be routed through the battery (e.g., temporarily stored in the battery) to the one or more Tx coils 425-a. In such cases, the Rx coils 430-b may charge the battery of the device charger 405-a to at least a threshold level of charge before the power from the battery is transferred to the Tx coils 425-a to charge the ring 104.

In some cases, the one or more first charging components (e.g., the one or more Rx coils 430-a), the one or more second charging components (e.g., the one or more Tx coils 425-a), or both, may be positioned (e.g., located) a threshold distance from the one or more third charging components (e.g., the one or more Rx coils 430-b), from the one or more fourth charging components (e.g., the one or more Tx coils 425-b), or both, to avoid interference between charging of the ring 104 and charging of the device charger 405-a. In other words, the respective Tx coils 425 and Rx coils 430 shown in FIG. 4 may be spaced from one another to prevent interference between the respective coils.

Additionally, or alternatively, the one or more second charging components of the device charger 405-a may be the same components as the one or more third charging components of the device charger 405-a. That is, the device charger 405-a may include one or more combined charging components that are capable of both wirelessly receiving energy and wirelessly transmitting energy.

Though depicted as a device charger 405-a with a post 420, this is not to be regarded as a limitation of the present disclosure. In this regard, any method or design of charging the ring 104 with the device charger 405-a may be supported, including, but not limited to, a cavity in which at least a portion of the ring 104 is placed within. Further, though described in the context of the one or more Rx coils 430 wirelessly transferring energy to the one or more Tx coils 425, this is not to be regarded as a limitation of the present disclosure. In this regard, any method or design of charging the device charger 405-a with the charger 405-b through the packaging 410, charging the ring 104 with the device charger 405-a, or both. may be supported, including, but not limited to, wired charging, contact-based charging, radio frequency charging, infrared charging, or the like thereof. For example, in some cases, energy may be wirelessly transferred from the Tx coils 425-b of the charger 405-b to the Rx coils 430-b of the device charger 405-a, where the power is transferred from the device charger 405-a to the ring 104 via contact-based charging mechanisms.

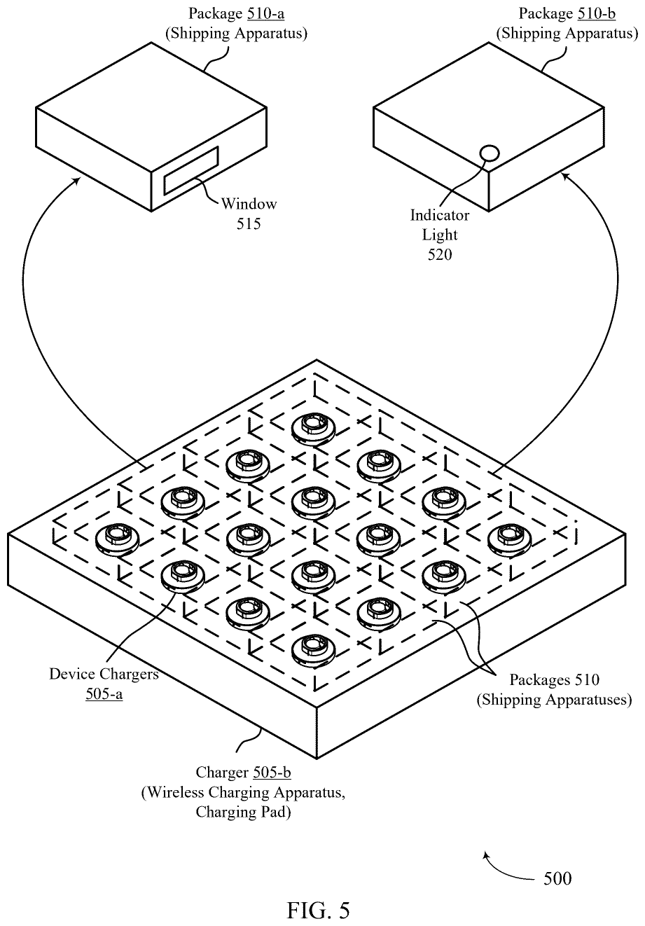

FIG. 5 shows an example of a system 500 that supports techniques for pre-charging wearable devices while packaged in accordance with aspects of the present disclosure. The system 500 may include one or more rings 104, one or more device chargers 505-a, and one or more chargers 505-b.

In some cases, multiple rings 104 may be activated while packaged for shipment. For example, multiple rings 104 may be shipped in bulk (e.g., research studies, military applications, enterprise customers, etc.) and an administrative user 102 may activate (e.g., turn on and update, pre-configure, or both) prior to distributing the rings 104 to respective end users 102. As an illustrative example, in a research study scenario, multiple rings 104 may be activated while still in respective packages 510 (e.g., packaging, shipment packaging) and each ring 104 may be pre-configured with one or more settings specific to an intended user 102, one or more settings specific to the research study, or both. For example, each ring 104 may be associated with a user profile containing an identification number, a user's height, a user's weight, and a user's age, such that the specific user 102 may receive the ring 104 pre-configured specifically for said user 102 while the ring 104 is still in the package 510, including associated accessories.

In some cases, to activate multiple rings 104 at a time, multiple packages 510 (e.g., each containing at least device charger 505-a and a ring 104) may be positioned on a single charger 505-b (e.g., wireless charging apparatus, charging pad), where the charger 505-b wirelessly transfers energy to each of the device chargers 505-a (e.g., at a same time). In some examples, the multiple packages 510 may further be packaged (e.g., positioned, arranged) together, which may be referred to as a bulk package, such that the bulk package may be positioned on or within a threshold proximity of the charger 505-b to charge the device chargers 505-a in the multiple packages 510 (e.g., at a same time). For example, multiple packages 510 may be packaged together in rows that are multiple packages 510 wide (e.g., and long) and a single package 510 high. Further, multiple rows of packages 510 may be stacked (e.g., arranged) such that space exists between each row of packages 510 (e.g., between rows of shipping crates), where a charger 505-b may be positioned within the space to charge chargers 505-a within packages 510 of a first row of packages 510 above the space, chargers 505-within a second row below the space, or both.

In some cases, to confirm a ring 104 within a package 510 has been charged, updated, pre-configured, or any combination thereof, the package 510, a device charger 505-a within the package 510, or both, may have one or more indicators. For example, a package 510-a may include a window 515, such that a user 102 may view the ring 104, the device charger 505-a, or both, within the package 510-a through the window 515. Additionally, the device charger 505-a, the ring 104, or both, may include an indicator light 520 (e.g., LED), where the indicator light 520 emits light during, after completion of, or both, charging, updating, pre-configuration, or any combination thereof. For example, the indicator light 520 may emit a red light while the ring 104 is charging, might emit a yellow light while the ring 104 is being updated, pre-configured, or both, and may emit a green light when the ring 104 has completed being updated, pre-configured, or both. Additionally, or alternatively, a package 510-b may have a similar indicator light 520. In such cases, similar to the indicator light 520 on the device charger 505-a, the indicator light 520 on the package 510 may emit light during, after completion of, or both, charging, updating, pre-configuration, or any combination thereof. In some cases, the indicator light 520 may determine when to emit light based on signaling from the ring 104, from the device charger 505-a, from a user device 106 communicating with the ring 104, or any combination thereof. Moreover, in cases where the package 510 itself includes an indicator light 520, the indicator light 520 may be configured to receive power from the device charger 505-a, the charger 505-b, the ring 104, or any combination thereof.

In some cases, the indicator light 520 may turn off when the ring 104 transitions back to the “ship mode.” That is, in some cases, the ring 104 may be unpackaged by a user 102 outside of (e.g., exceeding) a threshold duration, such that leaving the ring 104 on may risk damaging the battery. In such cases, after completion of updates, pre-configuration, or both, the user device 106 may be used to return to the ring 104 to the “ship mode” to protect the battery life until the ring 104 is removed from the package 510 for use by the user 102 (e.g., or activated for a second time while still in the package 510). For example, continuing with the research study scenario, an administrative user 102 may update and pre-configure the multiple rings 104 over a period of a week and may not distribute the rings 104 for another week. As such, after updating and pre-configuring the rings 104, the administrative user 102 may return the rings 104 to the “ship mode” and may confirm that the rings 104 returned to the “ship mode” by confirming that indicator lights 520 (e.g., on the package 510-b, on chargers 505-a, on rings 104, or any combination thereof) have turned off. As such, after distribution, a user 102 may activate their ring 104 after removing the ring 104 from package 510 and briefly placing the ring 104 on a device charger 505-a (e.g., without needing to update or pre-configure the device charger 505-a). Alternatively, within the threshold duration of distribution, the administrative user 102 may (e.g., in bulk or on an individual basis) place each package 510 on or near a charger 505-b for a second time to activate each ring 104, such that each user 102 may begin using their ring 104 immediately after removing the ring 104 from the package 510.

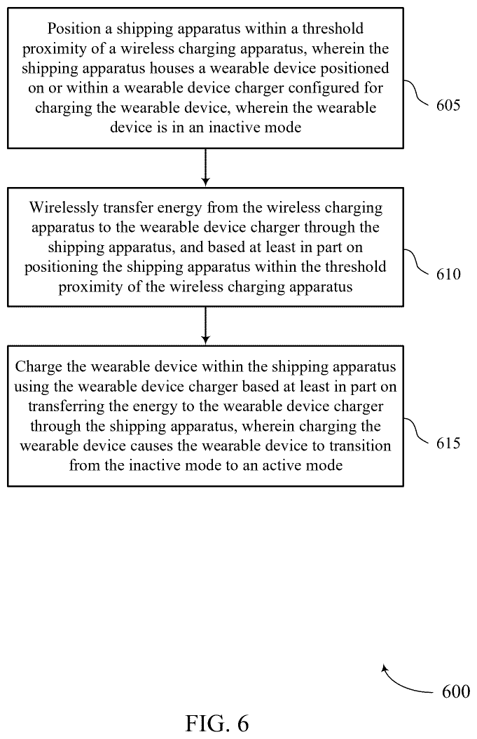

FIG. 6 shows a flowchart illustrating a method 600 that supports techniques for pre-charging wearable devices while packaged in accordance with aspects of the present disclosure. The operations of the method 600 may be implemented by a wearable device 104, a user 102, a user device 106, a wearable device charger, a wireless charging apparatus, a shipping apparatus, or any combination thereof.

At 605, the method may include positioning a shipping apparatus within a threshold proximity of a wireless charging apparatus, wherein the shipping apparatus houses a wearable device positioned on or within a wearable device charger configured for charging the wearable device, wherein the wearable device is in an inactive mode. The operations of 605 may be performed in accordance with examples as disclosed herein. In some examples, aspects of the operations of 605 may be performed by a user 102 as described with reference to FIG. 1.

At 610, the method may include wirelessly transferring energy from the wireless charging apparatus to the wearable device charger through the shipping apparatus, and based at least in part on positioning the shipping apparatus within the threshold proximity of the wireless charging apparatus. The operations of 610 may be performed in accordance with examples as disclosed herein. In some examples, aspects of the operations of 610 may be performed by a wireless charging apparatus as described with reference to FIG. 3.

At 615, the method may include charging the wearable device within the shipping apparatus using the wearable device charger based at least in part on transferring the energy to the wearable device charger through the shipping apparatus, wherein charging the wearable device causes the wearable device to transition from the inactive mode to an active mode. The operations of 615 may be performed in accordance with examples as disclosed herein. In some examples, aspects of the operations of 615 may be performed by a wearable device charger as described with reference to FIG. 3.

It should be noted that the methods described above describe possible implementations, and that the operations and the steps may be rearranged or otherwise modified and that other implementations are possible. Furthermore, aspects from two or more of the methods may be combined.

A method by an apparatus is described. The method may include positioning a shipping apparatus within a threshold proximity of a wireless charging apparatus, wherein the shipping apparatus houses a wearable device positioned on or within a wearable device charger configured for charging the wearable device, wherein the wearable device is in an inactive mode, wirelessly transferring energy from the wireless charging apparatus to the wearable device charger through the shipping apparatus, and based at least in part on positioning the shipping apparatus within the threshold proximity of the wireless charging apparatus, and charging the wearable device within the shipping apparatus using the wearable device charger based at least in part on transferring the energy to the wearable device charger through the shipping apparatus, wherein charging the wearable device causes the wearable device to transition from the inactive mode to an active mode.

A system is described. The apparatus may include one or more components. The one or more components may individually or collectively be operable to cause the system to position a shipping apparatus within a threshold proximity of a wireless charging apparatus, wherein the shipping apparatus houses a wearable device positioned on or within a wearable device charger configured for charging the wearable device, wherein the wearable device is in an inactive mode, wirelessly transfer energy from the wireless charging apparatus to the wearable device charger through the shipping apparatus, and based at least in part on positioning the shipping apparatus within the threshold proximity of the wireless charging apparatus, and wirelessly charge the wearable device within the shipping apparatus using the wearable device charger based at least in part on transferring the energy to the wearable device charger through the shipping apparatus, wherein charging the wearable device causes the wearable device to transition from the inactive mode to an active mode.

Another system is described. The system may include means for positioning a shipping apparatus within a threshold proximity of a wireless charging apparatus, wherein the shipping apparatus houses a wearable device positioned on or within a wearable device charger configured for charging the wearable device, wherein the wearable device is in an inactive mode, means for wirelessly transferring energy from the wireless charging apparatus to the wearable device charger through the shipping apparatus, and based at least in part on positioning the shipping apparatus within the threshold proximity of the wireless charging apparatus, and means for wirelessly charging the wearable device within the shipping apparatus using the wearable device charger based at least in part on transferring the energy to the wearable device charger through the shipping apparatus, wherein charging the wearable device causes the wearable device to transition from the inactive mode to an active mode.

Some examples of the method and systems described herein may further include components, operations, features, means, or instructions for transmitting, to the wearable device within the shipping apparatus, first signaling indicating for the wearable device to transition from the active mode back to the inactive mode.

Some examples of the method and systems described herein may further include components, operations, features, means, or instructions for transmitting, to the wearable device within the shipping apparatus and based at least in part on transitioning the wearable device to the active mode, first signaling that configures one or more parameters of the wearable device.

In some examples of the method and systems described herein, the one or more parameters may be associated with a firmware update, one or more user preferences, one or more user characteristics, or any combination thereof.

Some examples of the method and systems described herein may further include components, operations, features, means, or instructions for receiving, from the wearable device within the shipping apparatus while the wearable device may be in the active mode, second signaling indicating successful configuration of the one or more parameters of the wearable device.

Some examples of the method and systems described herein may further include components, operations, features, means, or instructions for emitting light from on or within the shipping apparatus via a light emitting component of the shipping apparatus, a light emitting component of the wearable device, the wearable device charger, or any combination thereof, based at least in part on transitioning the wearable device from the inactive mode to the active mode within the shipping apparatus.

In some examples of the method, apparatus, and non-transitory computer-readable medium described herein, the light may be emitted by the wearable device, the wearable device charger, or both, through a window disposed within the shipping apparatus.

In some examples of the method and systems described herein, the wearable device charger may be configured to receive the energy from the wireless charging apparatus using a first inductive component and the wearable device charger may be configured to wirelessly charge the wearable device using a second inductive component.

In some examples of the method and systems described herein, the wearable device charger may be configured to receive the energy from the wireless charging apparatus and wirelessly charge the wearable device using a single inductive component.

Some examples of the method and systems described herein may further include components, operations, features, means, or instructions for transferring the energy from the wireless charging apparatus to an energy storage component of the wearable device charger and wirelessly charging the wearable device using the energy storage component based at least in part on a power level of the energy storage component satisfying a threshold power level.

In some examples of the method and systems described herein, wirelessly transferring energy from the wireless charging apparatus to the wearable device charger through the shipping apparatus may include components, operations, features, means, or instructions for wirelessly transferring energy from the wireless charging apparatus to a plurality of wearable device chargers disposed within a plurality of shipping apparatuses, the plurality of wearable device chargers including the wearable device charger.

In some examples of the method and systems described herein, the wearable device may be a ring wearable device.

Another system is described. The system may include a housing configured to receive the wearable device, a first charging component positioned at least partially within the housing, the first charging component configured to wirelessly receive power from a wireless charging apparatus through a surface of a shipping apparatus while the wearable device charger is positioned within the shipping apparatus, and a second charging component disposed at least partially within the housing, the second charging component configured to wirelessly charge the wearable device positioned on or within the housing while the wearable device and the wearable device charger are positioned within the shipping apparatus and based at least in part on receiving the power through the surface of the shipping apparatus, wherein charging the wearable device causes the wearable device to transition from an inactive mode to an active mode.

In some examples of the systems described herein, an energy storage component disposed at least partially within the housing, the energy storage component configured to store the power received via the first charging component and configured to wirelessly charge the wearable device via the second charging component.

In some examples of the systems described herein, the power received via the first charging component may be transferred directly from the first charging component to the second charging component to wirelessly charge the wearable device.

In some examples of the systems described herein, the first charging component comprises a first inductive coil configured to wirelessly receive power and the second charging component comprises a second inductive coil configured to wirelessly transmit power.

In some examples of the systems described herein, a light-emitting component disposed at least partially on an outer surface of the housing and configured to emit light based at least in part on the wearable device transitioning from the inactive mode to the active mode, wherein the wearable device charger may be positioned within the shipping apparatus such that the light emitted by the light-emitting component may be emitted through a window of the shipping apparatus.

In some examples of the systems described herein, the wearable device may be a ring wearable device.

Another system is described. The system may include a wireless charging apparatus, a shipping apparatus, a wearable device charger positioned within the shipping apparatus, a wearable device positioned within the shipping apparatus in an inactive mode, the wearable device positioned on or within the wearable device charger, wherein the wearable device charger is configured to, wirelessly receive power from the wireless charging apparatus through a surface of the shipping apparatus while the wearable device charger and the wearable device are positioned within the shipping apparatus, and wirelessly charge the wearable device within the shipping apparatus based at least in part on wirelessly receiving the power through the shipping apparatus, wherein wirelessly charging the wearable device causes the wearable device to transition from the inactive mode to an active mode.

In some examples of the systems described herein, a light-emitting component disposed at least partially on an outer surface of the wearable device charger or the shipping apparatus, the light-emitting component configured to emit light based at least in part on the wearable device transitioning from the inactive mode to the active mode.

In some examples of systems described herein, a user device configured to transmit first signaling to the wearable device to transition the wearable device from the active mode back to the inactive mode, configure one or more parameters of the wearable device, receive second signaling indicating successful configuration of the wearable device, or any combination thereof.

In some examples of the systems described herein, the wireless charging apparatus may be configured to transmit power to a plurality of wearable device chargers positioned within a plurality of shipping apparatuses, the plurality of wearable device chargers including at least the wearable device charger positioned within the shipping apparatus.

In some examples of the systems described herein, a bulk distribution apparatus configured to support the plurality of shipping apparatuses and position the plurality of shipping apparatuses within a threshold proximity of the wireless charging apparatus in order to transmit the power from the wireless charging apparatus to the plurality of wearable device chargers within the plurality of shipping apparatuses.

In some examples of the systems described herein, a stabilization system configured to maintain a position of the wearable device positioned on or within the wearable device charger while the wearable device and the wearable device charger may be positioned within the shipping apparatus.

In some examples of the systems described herein, the wearable device may be a ring wearable device.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable ROM (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method, comprising:
positioning a shipping apparatus within a threshold proximity of a wireless charging apparatus, wherein the shipping apparatus houses a wearable device positioned on or within a wearable device charger configured for charging the wearable device, wherein the wearable device is in an inactive mode;
wirelessly transferring energy from the wireless charging apparatus to the wearable device charger through the shipping apparatus, and based at least in part on positioning the shipping apparatus within the threshold proximity of the wireless charging apparatus; and
charging the wearable device within the shipping apparatus using the wearable device charger based at least in part on transferring the energy to the wearable device charger through the shipping apparatus, wherein charging the wearable device causes the wearable device to transition from the inactive mode to an active mode.

2. The method of claim 1, further comprising:
transmitting, to the wearable device within the shipping apparatus, first signaling indicating for the wearable device to transition from the active mode back to the inactive mode.

3. The method of claim 1, further comprising:
transmitting, to the wearable device within the shipping apparatus and based at least in part on transitioning the wearable device to the active mode, first signaling that configures one or more parameters of the wearable device.

4. The method of claim 3, wherein the one or more parameters are associated with a firmware update, one or more user preferences, one or more user characteristics, or any combination thereof.

5. The method of claim 3, further comprising:
receiving, from the wearable device within the shipping apparatus while the wearable device is in the active mode, second signaling indicating successful configuration of the one or more parameters of the wearable device.

6. The method of claim 1, further comprising:
emitting light from on or within the shipping apparatus via a light emitting component of the shipping apparatus, a light emitting component of the wearable device, the wearable device charger, or any combination thereof, based at least in part on transitioning the wearable device from the inactive mode to the active mode within the shipping apparatus.

7. The method of claim 6, wherein the light is emitted by the wearable device, the wearable device charger, or both, through a window disposed within the shipping apparatus.

8. The method of claim 1, wherein the wearable device charger is configured to receive the energy from the wireless charging apparatus using a first contactless charging component, and wherein the wearable device charger is configured to charge the wearable device using a second contactless charging component, a contact-based charging component, or both.

9. The method of claim 1, wherein the wearable device charger is configured to receive the energy from the wireless charging apparatus and wirelessly charge the wearable device using a single contactless charging component.

10. The method of claim 1, further comprising:
transferring the energy from the wireless charging apparatus to an energy storage component of the wearable device charger; and
charging the wearable device using the energy storage component based at least in part on a power level of the energy storage component satisfying a threshold power level.

11. The method of claim 1, wherein wirelessly transferring energy from the wireless charging apparatus to the wearable device charger through the shipping apparatus further comprises:
wirelessly transferring energy from the wireless charging apparatus to a plurality of wearable device chargers disposed within a plurality of shipping apparatuses, the plurality of wearable device chargers including the wearable device charger.

12. A wearable device charger for charging a wearable device, comprising:
a housing configured to receive the wearable device;
a first charging component positioned at least partially within the housing, the first charging component configured to wirelessly receive power from a wireless charging apparatus through a surface of a shipping apparatus while the wearable device charger is positioned within the shipping apparatus; and
a second charging component disposed at least partially within the housing, the second charging component configured to charge the wearable device positioned on or within the housing while the wearable device and the wearable device charger are positioned within the shipping apparatus and based at least in part on receiving the power through the surface of the shipping apparatus, wherein charging the wearable device causes the wearable device to transition from an inactive mode to an active mode.

13. The wearable device charger of claim 12, wherein an energy storage component disposed at least partially within the housing, the energy storage component configured to store the power received via the first charging component and configured to charge the wearable device via the second charging component.

14. The wearable device charger of claim 12, wherein the power received via the first charging component is transferred directly from the first charging component to the second charging component to charge the wearable device.

15. The wearable device charger of claim 12, wherein the first charging component comprises a first contactless charging component configured to wirelessly receive power from the wireless charging apparatus, and wherein the second charging component comprises a second contactless charging component configured to wirelessly transmit power to the wearable device.

16. The wearable device charger of claim 12, wherein the first charging component comprises a first contactless charging component configured to wirelessly receive power from the wireless charging apparatus, and wherein the second charging component comprises a contact-based charging component configured to electrically contact the wearable device to transmit power to the wearable device.

17. The wearable device charger of claim 12, further comprising:
a light-emitting component disposed at least partially on an outer surface of the housing and configured to emit light based at least in part on the wearable device transitioning from the inactive mode to the active mode, wherein the wearable device charger is positioned within the shipping apparatus such that the light emitted by the light-emitting component is emitted through a window of the shipping apparatus.

18. A system for packaging and shipping wearable devices, comprising:
a wireless charging apparatus;
a shipping apparatus;
a wearable device charger positioned within the shipping apparatus; and
a wearable device positioned within the shipping apparatus in an inactive mode, the wearable device positioned on or within the wearable device charger, wherein the wearable device charger is configured to:
wirelessly receive power from the wireless charging apparatus through a surface of the shipping apparatus while the wearable device charger and the wearable device are positioned within the shipping apparatus; and
charge the wearable device within the shipping apparatus based at least in part on wirelessly receiving the power through the shipping apparatus, wherein charging the wearable device causes the wearable device to transition from the inactive mode to an active mode.

19. The system of claim 18, further comprising:
a user device configured to transmit first signaling to the wearable device to transition the wearable device from the active mode back to the inactive mode, configure one or more parameters of the wearable device, receive second signaling indicating successful configuration of the wearable device, or any combination thereof.

20. The system of claim 18, further comprising:
a stabilization system configured to maintain a position of the wearable device positioned on or within the wearable device charger while the wearable device and the wearable device charger are positioned within the shipping apparatus.
